(19) United States
(12) Patent Application Publication
(10) Pub. No.: US 2022/0058754 A1
(43) Pub. Date: Feb. 24, 2022

(54) SYSTEMS AND METHODS OF FACILITATING SOCIAL GATHERINGS COMPRISED OF A SOCIAL NETWORK, A GEOLOCATION SYSTEM, AND A SCHEDULING SYSTEM

(71) Applicant: FFLOK, Bordeaux (FR)

(72) Inventors: Aidan O'Brien, Bordeaux (FR); Olivier Locufier, Bordeaux (FR)

(21) Appl. No.: 17/415,162

(22) PCT Filed: Dec. 17, 2019
(86) PCT No.: PCT/IB2019/001332

§ 371 Date: Jun. 17, 2021

Related U.S. Application Data
(60) Provisional application No. 62/788,262, filed on Jan. 4, 2019.
(60) Provisional application No. 62/781,403, filed on Dec. 18, 2018.

(51) Int. Cl. G06Q 50/00; G07C 13/00; G06Q 30/06; G06Q 10/10

(52) U.S. Cl. CPC G06Q 50/01; G06Q 10/1095; G06Q 30/0609; G07C 13/00

(57) ABSTRACT

Computer-implemented systems and methods of facilitating social gatherings are provided. Disclosed systems and methods include a user interface, a contact database comprising a limited number of a user's close contacts, a geolocation system, and a scheduling system. The scheduling system includes a suggestion system and a voting system. A close contact appears on the user interface as an individual image within a bubble. The geolocation system determines the locations of the close contacts. The suggestion system suggests merchants to the user/organizer. The scheduling system enables the organizer to select one or more close contacts forming a group and send an invitation for a gathering containing suggested merchants to the group. The voting system enables the group to vote on the suggested merchants, and the suggested merchant receiving the most votes becomes a selected merchant. The reservation system sends a notification to the selected merchant having the most votes. The geolocation system provides a notification to the user when a close contact is in a zone of close proximity to the user and informs the user how much time it will take for each close contact in the group to reach the user.

### CROSS-REFERENCE TO RELATED APPLICATIONS

This application claims priority to and benefit of U.S. Patent Application No. 62/788,262, filed Jan. 4, 2019, and U.S. Patent Application No. 62/781,403, filed Dec. 18, 2019, each of which is hereby incorporated by reference in its entirety.

### FIELD OF THE DISCLOSURE

The present disclosure relates to computer-implemented systems and methods of facilitating spontaneous social gatherings using a social network, a geolocation system, and a scheduling system that includes a voting system.

### BACKGROUND

Getting your group of friends or family together for travel, social activities such as shopping or going to the movies, or social gatherings in suitable restaurants, bars, or cafes takes time and energy. This is because it requires looking up email addresses and phone numbers and composing group emails or texts or making multiple telephone calls. If social media platforms are used for such communications, the user also needs to log into those applications or web sites. It also typically requires coordinating the schedules and dietary restrictions or food preferences of several different people. The organizer needs to consult individual gather locations web sites and/or gathering locations review sites. Accordingly, people are usually just too busy or overworked and don't have the time and energy to arrange gatherings with close friends or family.

These difficulties coupled with a wide variety of social media and electronic communications options mean that we are more connected than ever digitally, but we are less connected in real life. Often, people end up spending more time chatting with a keyboard or mobile device screen than talking in real life. Although there may be times when travel or other circumstances bring close friends or family members near to each other, they may not be aware of this and the opportunity for them to get together in person is missed. We know that when we are together in real life, special moments occur. We shouldn't lose touch with the people who matter most and shouldn't have to choose between work, family and friends.

Thus, there is a need for a system and method of facilitating gatherings that makes it easy for people to arrange spontaneous social gatherings. There is a need for a system and method that can suggest gathering locations such as bars, restaurants, cafes, stores, and travel accommodations that are convenient and amenable to all members of a social group. There is also a need for a system and method which notifies a user when one of his close circle of family and friends is within close proximity and available to meet. There is a need for a single system and method of facilitating spontaneous gatherings that makes it easy for people to schedule social gatherings with the people who matter most.

### SUMMARY

The present disclosure, in its many embodiments, alleviates to a great extent the disadvantages of current methods of arranging social gatherings by providing a mobile application that facilitates the organizing and scheduling of spontaneous social gatherings. The present disclosure comprises hardware, software and firmware that allows users to invite a group of close contacts to get together, vote on a location to gather at, and schedule a spontaneous social gathering at the selected location. Disclosed systems and methods revolutionize how people find themselves together in real life. Exemplary embodiments enable spontaneous gatherings with the people who matter most so that no matter how busy life gets, users never miss an opportunity to stick together and get together with the people who matter most.

The mobile application described herein brings an end to the endless messages and phone calls required to bring people together. Exemplary embodiments learn and understand preferences for meeting places of the group and identify new places where similar groups have had a good time. The user downloads the mobile application, then identifies the people with whom he or she really wants a richer relationship. The app tells the user when those people are nearby and proposes groups and places for a spontaneous gathering with those people.

Exemplary embodiments may comprise both a business/merchant side or platform and a consumer side or platform. The business/merchant side is comprised of a marketplace of gathering locations/merchants allowing owners of the gathering locations such as restaurants, bars, cafes, stores, hotels, etc. to register their gathering locations. The consumer side may be comprised of a social network and geolocation system allowing users to connect with a limited number of close contacts. The consumer side identifies the close contacts who are in close proximity to the user and who are free for gatherings with the user. The system connects the owners of gathering locations with users by suggesting gathering locations for one or more of the close contacts and the user. Then the system schedules spontaneous gatherings for one or more of the close contacts and the user at one of the registered or unregistered gathering locations.

Exemplary embodiments of a computer-implemented system of facilitating social gatherings comprise a user interface, a contact database, a geolocation system, and a scheduling system. The contact database comprises a limited number of a user's close contacts. The geolocation system determines the locations of the close contacts. The scheduling system comprises a suggestion system suggesting merchants and a voting system. The scheduling system enables the user/organizer to select one or more close contacts forming a group and send an invitation for a gathering containing suggested merchants to the group. The voting system enables the group to vote on the suggested merchants, and the scheduling system sends a notification to the selected merchant having the most votes.

In exemplary embodiments, each close contact appears on the user interface as an individual image within a bubble. When the user/organizer selects at least one close contact the corresponding bubble is activated. The bubble may be grayed out before being activated and change to color when activated. In exemplary embodiments, a video associated with the close contact plays on the user interface when the bubble is activated.

In exemplary embodiments, the scheduling system provides a notification to the organizer when every close contact in the group has voted on a suggested merchant or when a pre-determined time period, e.g., 30-60 minutes, has run out. The voting system may provide each close contact in the group the ability to vote by making one or more choices between two suggested merchants. The suggested merchant receiving the most votes may become a selected merchant. In exemplary embodiments, the voting system enables the user/organizer to accept or reject the selected merchant. In exemplary embodiments, the scheduling system allows the group to observe which close contacts in the group plan to attend the gathering. In exemplary embodiments, the geolocation system tracks each close contact's movement toward the selected merchant and informs the user how much time it will take for each close contact in the group to arrive at the selected merchant.

The geolocation system may also provide a notification to the user when a close contact is in a zone of close proximity to the user. The zone of close proximity may be a zone of up to about 15 km from the user. The scheduling system may provide a notification to the user/organizer indicating that the close contact in the zone of close proximity to the user is free to meet, e.g., because that close contact does not have an appointment on his or her calendar at that time. In exemplary embodiments, the geolocation system informs the user how much time it will take for each close contact in the group to reach the user.

Exemplary methods of scheduling social gatherings comprise maintaining a contact database comprised of a limited number of a user's close contacts, displaying each close contact, determining locations of the user's close contacts, enabling the user to select one or more close contacts forming a group, suggesting merchants to the user, and enabling the user to send an invitation to the group for a gathering containing suggested merchants. Each close contact is displayed as an individual image within a bubble. When the user/organizer selects the one or more close contacts the corresponding bubbles are activated. Exemplary embodiments also enable the group to vote on the suggested merchants. Suggested merchants may be notified that they are being considered for a social gathering before or during the voting. The suggested merchant receiving the most votes becomes a selected merchant, and exemplary embodiments may send a notification to the selected merchant having the most votes.

In exemplary embodiments, the group voting step comprises providing each close contact in the group the ability to vote by making one or more choices between two suggested merchants. A notification may be provided to the organizer when every close contact in the group has voted on a suggested merchant, and the organizer may be provided the ability to accept or reject the selected merchant. Exemplary methods may further comprise allowing the organizer and/or close contacts in the group to observe which close contacts in the group plan to attend the gathering.

Exemplary methods may further comprise tracking each close contact's movement toward the selected merchant including informing the user how much time it will take for each close contact in the group to arrive at the selected merchant. In exemplary embodiments, the user is notified when a close contact is in a zone of close proximity to the user. The zone of close proximity may be a zone of up to about 15 km from the user. Exemplary embodiments further comprise informing the user how much time it will take for each close contact in the group to reach the user.

Computer-implemented marketplaces for connecting merchants and groups of customers are also described herein. An exemplary marketplace comprises a registration system and a scheduling system comprising a suggestion system, a messaging system, and a voting system. The registration system enables a merchant to register and create a merchant profile and enables the merchant to connect to a social network of customers. The suggestion system suggests merchants to a customer. The messaging system enables the registered merchant to send a message to a group of customers choosing among suggested merchants for a location for a social gathering. The voting system enables a group of customers to select a merchant for a social gathering and send a notification to the selected merchant.

In exemplary embodiments, the scheduling system enables the customer to select one or more close contacts forming a group and send an invitation for a gathering containing suggested merchants to the group. A voting system may also be provided which enables the group to vote on the suggested merchants. In exemplary embodiments, the voting system enables the group to vote on the suggested merchants by providing each close contact in the group the ability to vote by making one or more choices between two suggested merchants. The suggestion system may feature registered merchants and may suggest only registered merchants. In exemplary embodiments, the suggestion system does not restrict the restaurant proposals to registered merchants. Rather, it offers groups what the suggestion system deems to be the best options for the group. The reservation system may provide a notification to the merchant indicating that the group of customers plans to attend the social gathering.

Accordingly, it is seen that systems and methods of facilitating spontaneous gatherings are provided. These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a perspective view of an exemplary embodiment of a system of facilitating social gatherings in accordance with the present disclosure;

FIG. 2A is a perspective view of an exemplary embodiment of a system of facilitating social gatherings showing an exemplary contact database in accordance with the present disclosure;

FIG. 2B is a perspective view of an exemplary embodiment of a system of facilitating social gatherings showing an exemplary contact database in accordance with the present disclosure;

FIG. 3 is a perspective view of an exemplary embodiment of a system of facilitating social gatherings showing an exemplary scheduling system in accordance with the present disclosure;

FIG. 4 is a perspective view of an exemplary embodiment of a system of facilitating social gatherings showing an exemplary scheduling system in accordance with the present disclosure;

FIG. 5A is a perspective view of an exemplary embodiment of a system of facilitating social gatherings showing an exemplary Magic Moment in accordance with the present disclosure;

FIG. 5B is a perspective view of an exemplary embodiment of a system of facilitating social gatherings showing an exemplary Magic Moment in accordance with the present disclosure;

FIG. 5C is a perspective view of an exemplary embodiment of a system of facilitating social gatherings showing an exemplary Magic Moment in accordance with the present disclosure;

FIG. 6A is a perspective view of an exemplary embodiment of a system of facilitating social gatherings showing exemplary flock creation in accordance with the present disclosure;

FIG. 6B is a perspective view of an exemplary embodiment of a system of facilitating social gatherings showing exemplary flock creation in accordance with the present disclosure;

FIG. 7 is a perspective view of an exemplary embodiment of a system of facilitating social gatherings showing an exemplary voting system in accordance with the present disclosure;

FIG. 8 is a perspective view of an exemplary embodiment of a system of facilitating social gatherings showing an exemplary geolocation system in accordance with the present disclosure;

FIG. 9 is a perspective view of an exemplary embodiment of a system of facilitating social gatherings showing an exemplary loading page for onboarding in accordance with the present disclosure;

FIG. 10 is a perspective view of an exemplary embodiment of a system of facilitating social gatherings showing an exemplary loading page for adding contacts in accordance with the present disclosure;

FIG. 11A is a perspective view of an exemplary embodiment of a system of facilitating social gatherings showing an exemplary page for adding contacts in accordance with the present disclosure;

FIG. 11B is a perspective view of an exemplary embodiment of a system of facilitating social gatherings showing an exemplary page for adding contacts in accordance with the present disclosure;

FIG. 11C is a perspective view of an exemplary embodiment of a system of facilitating social gatherings showing an exemplary page for adding contacts in accordance with the present disclosure;

FIG. 11D is a perspective view of an exemplary embodiment of a system of facilitating social gatherings showing an exemplary page for adding contacts in accordance with the present disclosure;

FIG. 11E is a perspective view of an exemplary embodiment of a system of facilitating social gatherings showing an exemplary page for adding contacts in accordance with the present disclosure;

FIG. 12A is a perspective view of an exemplary embodiment of a system of facilitating social gatherings showing an exemplary page for adding a video to a user profile in accordance with the present disclosure;

FIG. 12B is a perspective view of an exemplary embodiment of a system of facilitating social gatherings showing an exemplary page for adding a video to a user profile in accordance with the present disclosure;

FIG. 13 is a perspective view of an exemplary embodiment of a system of facilitating social gatherings showing an exemplary page for selecting confidentiality settings in accordance with the present disclosure;

FIG. 14A is a perspective view of an exemplary embodiment of a system of facilitating social gatherings showing an exemplary page for selecting profile options and a user role in accordance with the present disclosure;

FIG. 14B is a perspective view of an exemplary embodiment of a system of facilitating social gatherings showing an exemplary page for selecting profile options and a user role in accordance with the present disclosure;

FIG. 14C is a perspective view of an exemplary embodiment of a system of facilitating social gatherings showing an exemplary page for selecting profile options and a user role in accordance with the present disclosure;

FIG. 15A is a perspective view of an exemplary embodiment of a system of facilitating social gatherings showing an exemplary page for exploring local merchants in accordance with the present disclosure;

FIG. 15B is a perspective view of an exemplary embodiment of a system of facilitating social gatherings showing an exemplary page for exploring local merchants in accordance with the present disclosure;

FIG. 16A is a perspective view of an exemplary embodiment of a system of facilitating social gatherings showing an exemplary page for inviting close contacts to a social gathering in accordance with the present disclosure;

FIG. 16B is a perspective view of an exemplary embodiment of a system of facilitating social gatherings showing an exemplary page for inviting close contacts to a social gathering in accordance with the present disclosure;

FIG. 16C is a perspective view of an exemplary embodiment of a system of facilitating social gatherings showing an exemplary page indicating which close contacts are attending a social gathering in accordance with the present disclosure;

FIG. 17A is a perspective view of an exemplary embodiment of a system of facilitating social gatherings showing an exemplary Define Event page in accordance with the present disclosure;

FIG. 17B is a perspective view of an exemplary embodiment of a system of facilitating social gatherings showing an exemplary Define Event page in accordance with the present disclosure;

FIG. 18A is a perspective view of an exemplary embodiment of a system of facilitating social gatherings showing an exemplary voting system in accordance with the present disclosure;

FIG. 18B is a perspective view of an exemplary embodiment of a system of facilitating social gatherings showing an exemplary voting system in accordance with the present disclosure;

FIG. 18C is a perspective view of an exemplary embodiment of a system of facilitating social gatherings showing an exemplary voting system in accordance with the present disclosure;

FIG. 18D is a perspective view of an exemplary embodiment of a system of facilitating social gatherings showing an exemplary voting system in accordance with the present disclosure;

FIG. 19 is a perspective view of an exemplary embodiment of a system of facilitating social gatherings showing an exemplary voting system in accordance with the present disclosure;

FIG. 20A is a perspective view of an exemplary embodiment of a system of facilitating social gatherings showing an exemplary voting system in accordance with the present disclosure;

FIG. 20B is a perspective view of an exemplary embodiment of a system of facilitating social gatherings showing an exemplary voting system in accordance with the present disclosure;

FIG. 20C is a perspective view of an exemplary embodiment of a system of facilitating social gatherings showing an exemplary voting system in accordance with the present disclosure;

FIG. 21 is a perspective view of an exemplary embodiment of a system of facilitating social gatherings showing an exemplary scheduling system in accordance with the present disclosure;

FIG. 22A is a perspective view of an exemplary embodiment of a system of facilitating social gatherings showing an exemplary flock failure in accordance with the present disclosure;

FIG. 22B is a perspective view of an exemplary embodiment of a system of facilitating social gatherings showing an exemplary flock failure in accordance with the present disclosure;

FIG. 23A is a perspective view of an exemplary embodiment of a system of facilitating social gatherings showing an exemplary scheduling system in accordance with the present disclosure;

FIG. 23B is a perspective view of an exemplary embodiment of a system of facilitating social gatherings showing an exemplary voting system in accordance with the present disclosure;

FIG. 23C is a perspective view of an exemplary embodiment of a system of facilitating social gatherings showing an exemplary scheduling system in accordance with the present disclosure; and

FIG. 23D is a perspective view of an exemplary embodiment of a system of facilitating social gatherings showing an exemplary geolocation system in accordance with the present disclosure.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

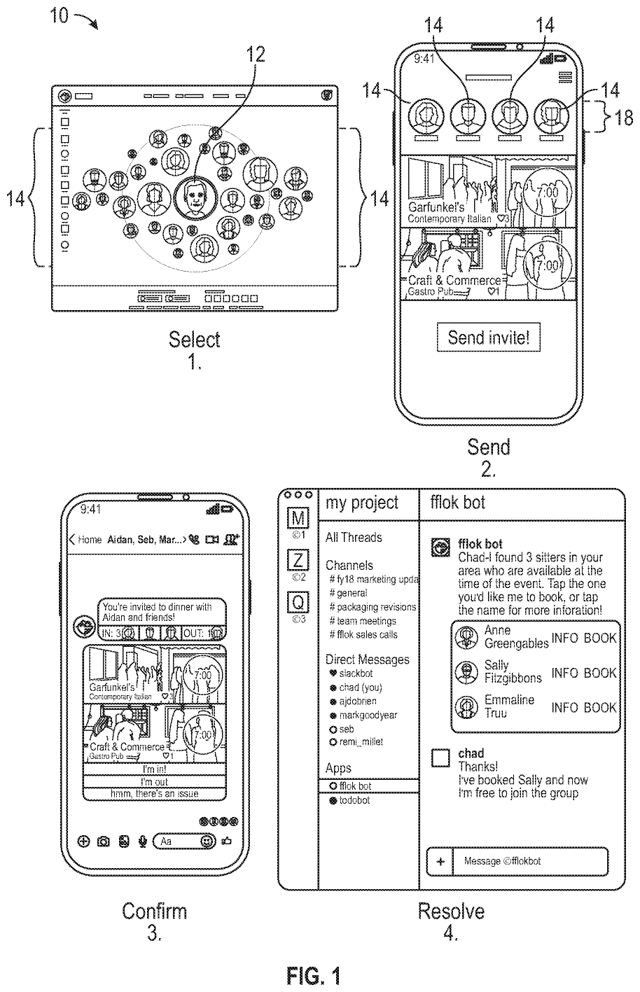

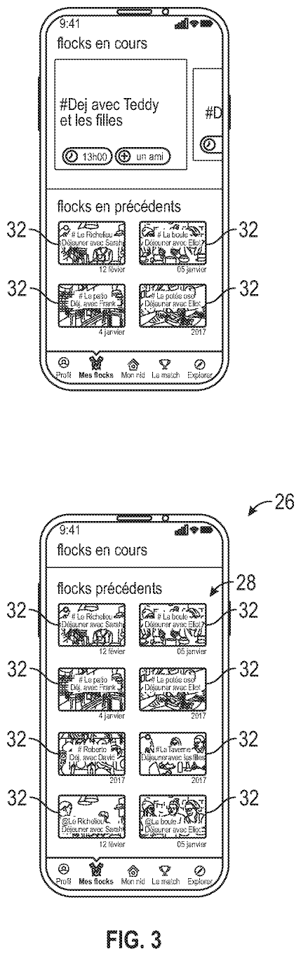

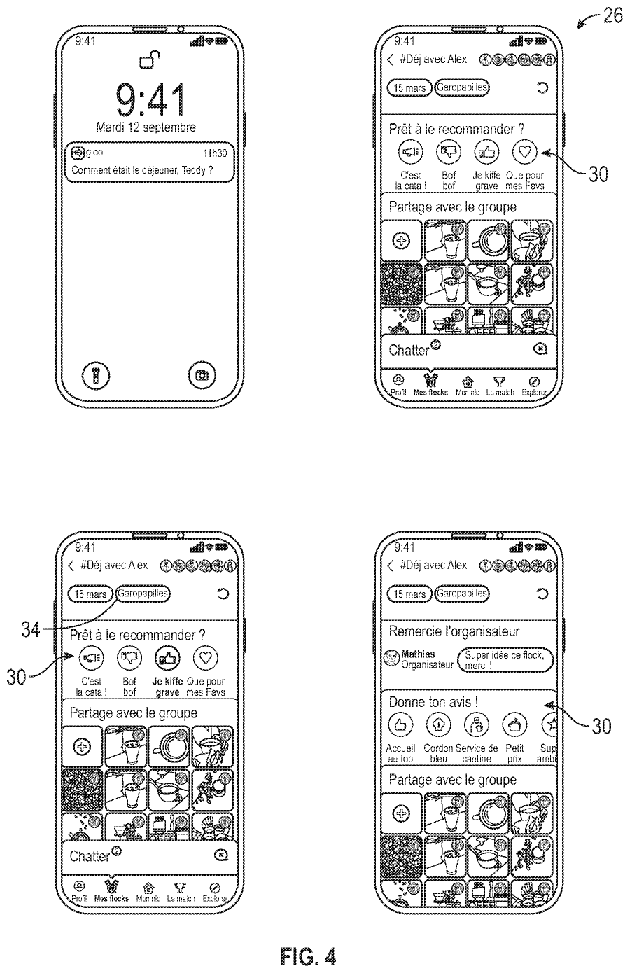

FIGS. 1-4 illustrate exemplary embodiments of a computer-implemented system 10 of facilitating social gatherings. The system and associated methods advantageously provide a complete ecosystem for facilitating spontaneous social gatherings. In other words, it is a closed or self-contained platform that includes a social network and contact database, a merchant network including information about restaurants, shopping, travel accommodations, etc., a complete voting/scheduling system, and a geolocation system for keeping track of the locations of one's close contacts and determining who is free to get together. Thus, the embodiments described herein allow people to get their core network of close friends and family physically together in real life via one system without the need to deal with disparate social networks, emails, phone calls, or text messages. This leads to spontaneous in-person gatherings without planning.

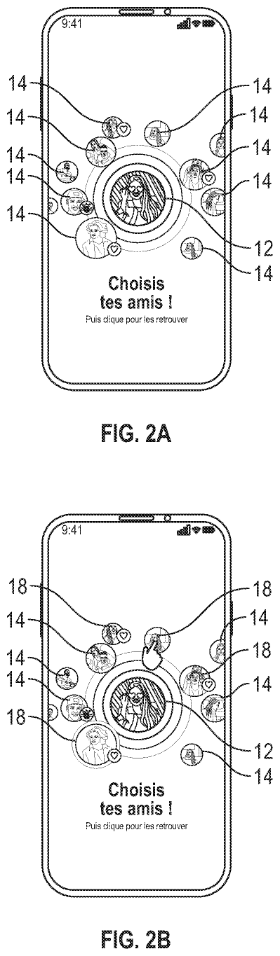

A partial overview of system 10 is shown in FIG. 1 from the point of view of an individual user in the first, second, and fourth views and a close contact of the user in the third view, and in FIGS. 2A, 2B, 3 and 4. The user 12 has a small circle of close contacts 14 made up of close friends and/or family members. If the user 12 wants to arrange a gathering of one or more of his or her close contacts 14, the user selects the close contacts he or she wants to invite through the system's mobile app and each of the contacts receives the invitation. As discussed in more detail herein, the system 10 keeps track of the locations of the user's close contacts and notifies the user 12 when a close contact 14 is in a zone of close proximity to the user. This notification can be the springboard for organizing an in-person social gathering.

The close contacts 14 indicate their availability for a gathering and the system 10 suggests a merchant 16 or location at which the group 18 can meet. The close contacts 14 in the group 18 can vote on suggested merchants 32, and the merchant with the most votes may become the selected merchant 34, if approved by the user/organizer 12. The system may send a notification to the selected merchant 34 to determine availability to host the gathering. It should be noted that both selected and unselected merchants may be notified of the outcome of the vote. The system notifies the user when everyone in the group has voted and how far each close contact 14 is from the selected merchant 34 or gathering location.

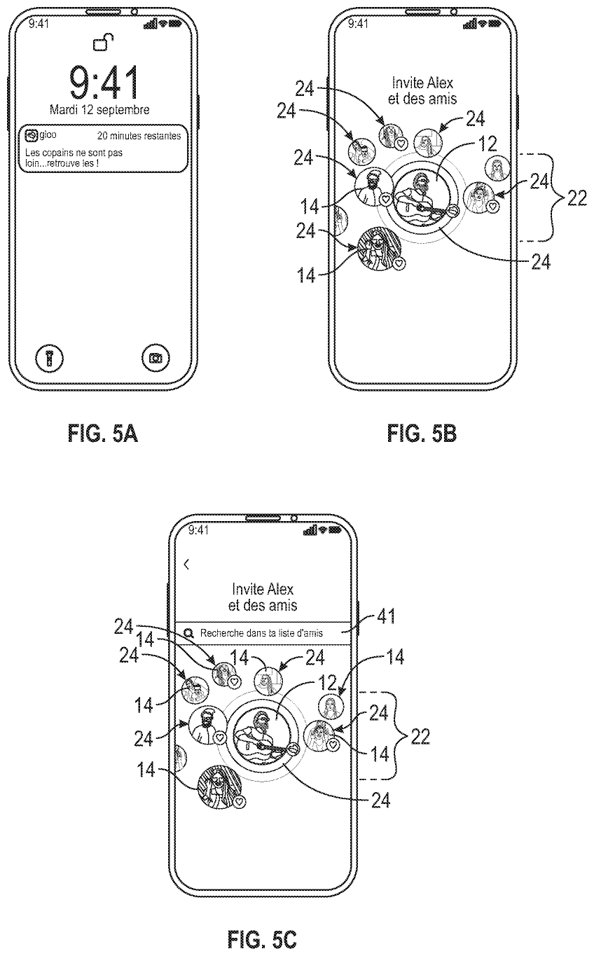

Turning now to FIGS. 5A-7, an exemplary system of facilitating social gatherings will now be described in detail. System 10 can be software, hardware, or firmware that runs on any type of computer that includes a processor, memory, and other components and systems. In exemplary embodiments, system 10 is a downloadable mobile application for smartphones. The downloaded app has a user interface 20 with hundreds of unique screens associated with the functions of the system. The system also includes a database 22 or list of the user's close contacts 14. Unlike a list of contacts on a smartphone or “friends” in a typical social network, this application is not intended for maintaining hundreds of “friends” most of whom are not close contacts. Rather, the idea of the application is for the user's network to consist of a limited number of close contacts. That number could be in the range of single digits up to about fifty or could be unlimited, but the individuals in the contact database should be close contacts with whom the user desires to regularly get together with in person.

Exemplary embodiments employ a unique methodology for displaying the close contacts 14 on the user interface 20. As best seen in FIGS. 5B and 5C, close contacts 14 appear on the user interface 20 as individual images within bubbles 24. Each bubble 24 corresponds to a close contact 14 with the contact's picture inside the bubble. The bubbles 24 are arrayed in a roughly circular configuration around the user's bubble 24, which is located in the center of the circular array. In exemplary embodiments, the user's bubble 24 is relatively larger than the bubbles 24 of the his or her close contacts 14. The bubbles 24 corresponding to the close contacts 14 are in gray color or grayed out as a default setting. In exemplary embodiments, when a user selects a close contact 14 to be invited to a social gathering, the bubble 24 of that contact becomes activated and changes to a different color. Also, a video uploaded by the selected close contact 14 may be played when that contact's bubble 24 is activated. Collectively, the close contacts 14 chosen by the user/organizer 12 for a prospective social gathering become a group 18.

Exemplary systems and methods further include a scheduling system 26 to handle the process of coordinating spontaneous in-person social gatherings. There are at least two components of the scheduling system: a suggestion system 28 and a voting system 30. Suggestion system 28 draws from the user/organizer's close contacts 14 for a potential group to meet and a list of merchants to suggest gathering locations for the user/organizer 12. The suggested merchants 32 are selected by the suggestion system 28 based on proximity to the group 18 and past gathering locations that the group or individual close contacts 14 in the group have enjoyed and could include restaurants, bars, cafes, shops, travel locations or accommodations, etc. In exemplary embodiments, the suggestion system 28 employs certain rules for suggesting restaurants, including but not limited to, distance of the different locations from the different participants, ratings of the different locations, price range of the different locations, and/or novelty, i.e., how often the app has displayed a particular location. As described in more detail herein, the user/organizer 12 sends an invitation to get together to each close contact 14 of the group 18 via the scheduling system 26, and the suggestion system 28 includes these suggested merchants 32 with the invitation.

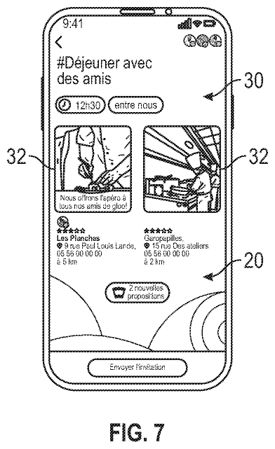

Exemplary embodiments of a voting system 30 provide unique functionality for voting on suggested merchants 32. The voting system 30 enables the group 18 of close contacts 14 invited by the organizer 12 to vote on the suggested merchants 32. As best seen in FIG. 7, in exemplary embodiments voting system 30 provides a voting sequence whereby each close contact 14 in the group 18 can narrow down the suggested merchant 32 options by making a series of choices between two suggest merchants or gather locations. In other words, during voting the user interface 20 displays two suggested merchants 32 on a screen. The organizer 12 selects one of the two suggested merchants 32 on the screen and then the voting system 30 displays that initial selected merchant with another suggested merchant 32 on the user interface 20. This process is repeated until only one suggested merchant 32 remains, i.e., the close contact 14 has made a final selection of a merchant.

After each close contact 14 in the group 18 has finished his or her individual voting process, the voting system 30 tallies the votes and the suggested merchant with the most votes becomes the selected merchant 34, i.e., the chosen gathering location. The organizer 12 is notified that every close contact 14 in the group 18 has voted on a suggested merchant 32. The voting system 30 provides the user 12 with the option of accepting or rejecting the selected merchant 34. If the organizer 12 accepts the selected merchant 34, then the mobile app labels the user a “democrat.” If the user 12 rejects the selected merchant and chooses a different merchant instead, her or she is labeled a “tyrant.”

Once voting is completed and the selected merchant 34 is approved by the user 12, the scheduling system 26 sends a notification to the selected merchant 34 that it has been chosen as the location for the social gathering. In exemplary embodiments, the scheduling system 26 may send a notification to the selected merchant 34 to determine whether the merchant's gathering location can accommodate the group 18. In exemplary embodiments, scheduling system 26 allows each close contact 14 in the group 18 to indicate whether they will attend the gathering and provides a notification to the organizer 12 indicating which close contacts in the group plan to attend.

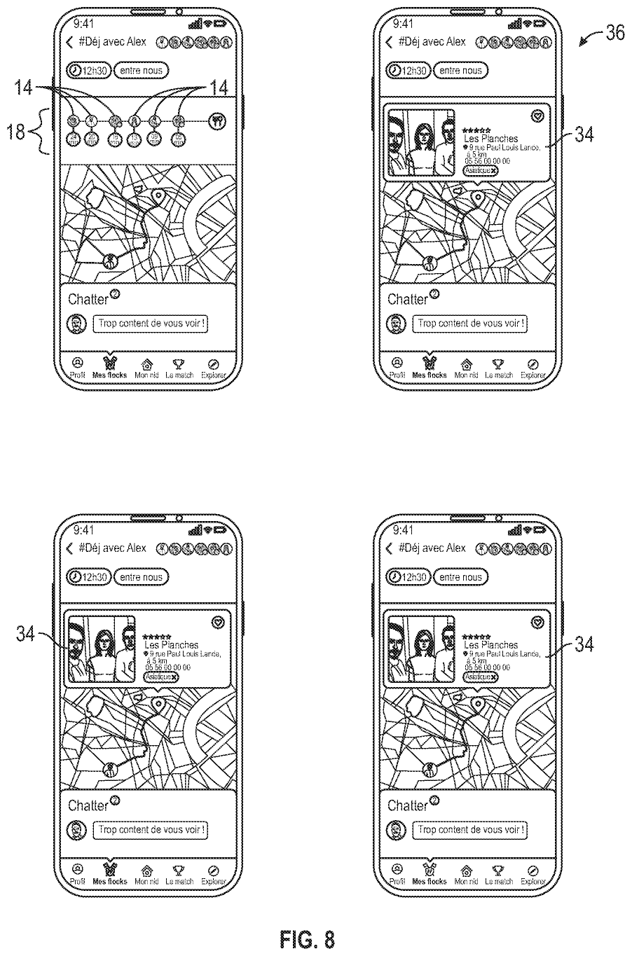

Turning to FIGS. 5A and 8, an exemplary geolocation system 36 will now be described. The geolocation system is a key component in creating the “magic moments” because, among other things, it serves to alert users when their friends and family are nearby and therefore that a spontaneous meeting may be possible. In exemplary embodiments, the geolocation system 36 determines the locations of the close contacts 14 in the user's contact database 22 and knows the distance between the user 12 and each close contact 14. However, it will not disclose the distance but will instead, in exemplary embodiments, share with the user 12 the amount of time it would take for the close contact 14 to reach the user or vice versa.

Geolocation system 36 will provide a notification to the user 12 when a close contact 14 is in close proximity to the user. The zone of close proximity could vary by location, e.g., a city, suburb or rural area. In exemplary embodiments, the zone of close proximity is an area up to about a 40-kilometer (about 24-25 miles) radius. In exemplary embodiments, the zone of close proximity is an area up to about a 15-kilometer (about 9-10 miles) radius. For example, if a close contact 14 is two km away from the user 12, the geolocation system 36 might provide an alert to the user indicating that the close contact is nearby. In exemplary embodiments, the user can see the locations of all his close contacts in the nest. The first page might show the close contacts in a 15 km radius, and the user can scroll to the right to see everyone else, i.e., close contacts outside of the zone of close proximity.

In exemplary embodiments, geolocation system 36 works in conjunction with scheduling system 26 in the sense that it tracks the progress of the close contacts 14 in the group 18 as they converge on the selected gathering location. More particularly, the geolocation system 36 tracks each close contact's 14 movement toward the selected merchant 34. As noted above, it will not inform the user 12 or other close contacts 14 of any close contact's particular location but instead notifies the user how much time it will take for each close contact 14 in the group 18 to arrive at the selected merchant/gathering location 34.

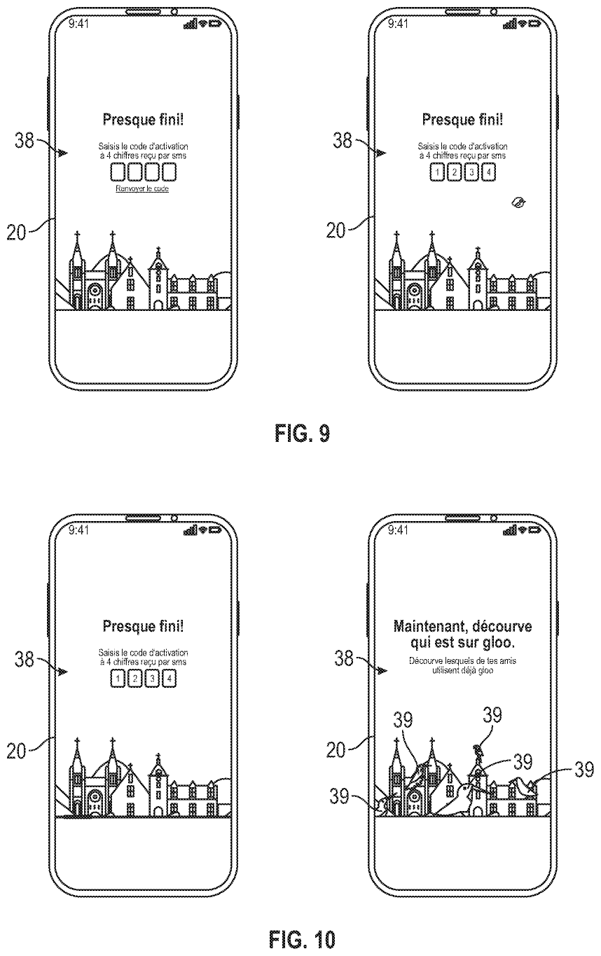

In operation, a user 12 begins by downloading the mobile application that comprises an exemplary system and method of facilitating spontaneous gatherings. The onboarding experience includes display of one or more loading pages on the user interface 20. An exemplary loading page 38 for onboarding is shown in FIGS. 9 and 10. In exemplary loading pages, one or more birds 39 arrive and land one after the other, in sequence, to signify the user's new ability to create a flock, or group of close contacts. There may be a video tutorial provided to teach the user how to use the app. One or more welcome screens may have a bird enter from the top of the screen to greet the new user. The welcome screens include areas to input user information such as name and age.

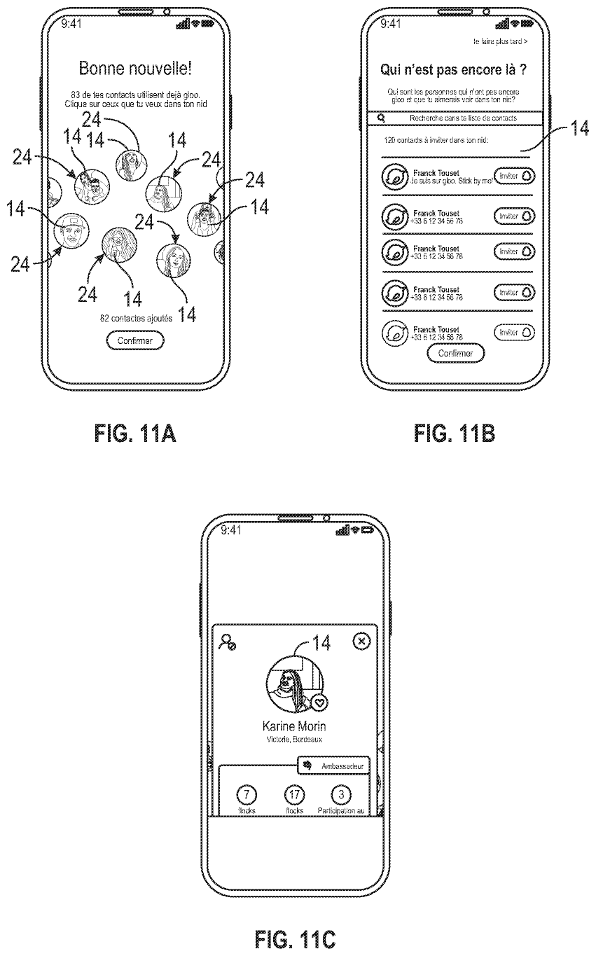

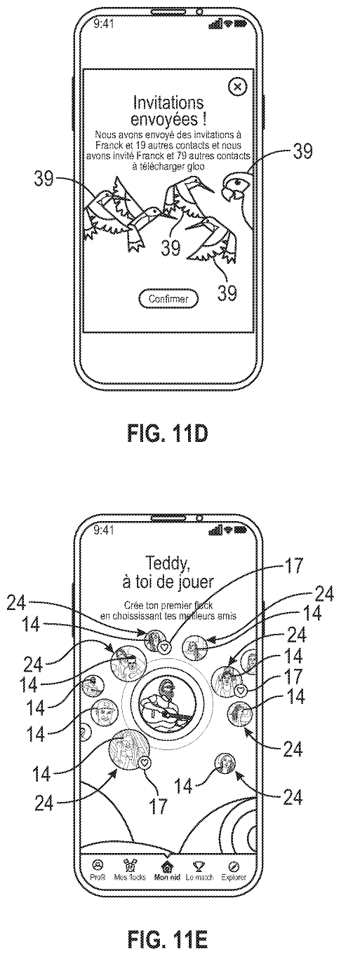

An important part of the setup process is entering one's contacts and inviting close contacts to social gatherings. As shown in FIGS. 11A-11C, there are several screens that prompt and enable the user to add his or her contacts to the contact database. The user could do this by providing access to his or her phone book on their smartphone so they can be imported in the contact database of the mobile app. Alternatively, the user could manually enter her contacts. By tapping a contact in the mobile app's contact database, the user selects a particular contact and then can validate the contacts he wants to be in his nest, or database of close contacts 14. To deselect a contact, the user re-taps on the contact.

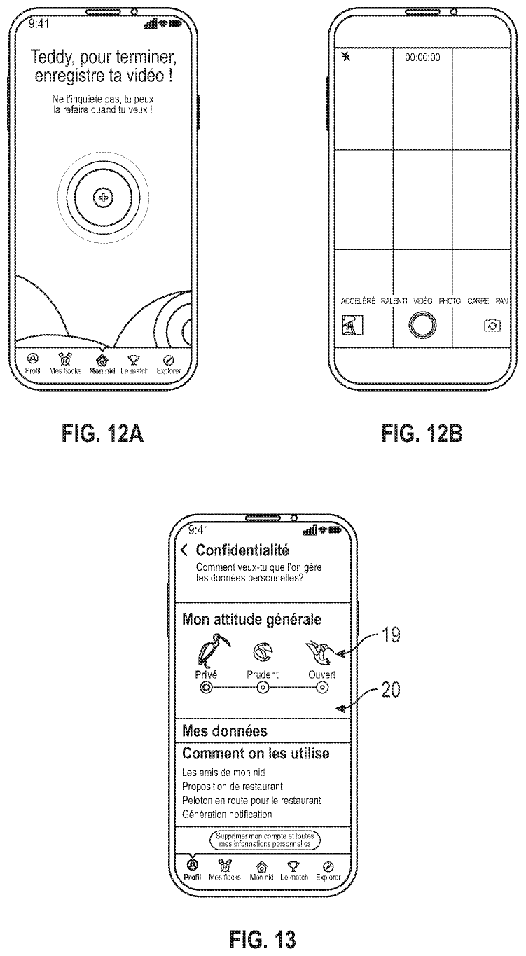

If the user proceeds without inviting any contacts, the mobile app provides a notification or warning that the user will have an empty nest. For contacts who have not downloaded the mobile app and therefore are not part of the system 10, the user can invite them through the app, and these invitations could be sent via SMS text messages. The mobile app has at least one screen showing “Your Nest” showing the user's close contacts. Exemplary embodiments may include a search bar so the user can select the close contacts she wants to see in her nest. In exemplary embodiments, the last onboarding step is to couple a video with her profile, as illustrated in FIGS. 12A and 12B. The user records and saves his profile video and then validates the video to add it to his profile. At any time after completion of the profile, the user can access a screen that shows how to modify the profile, video, and name if desired. The app may have a specific version of a profile page to indicate that the user is offline.

He also has the opportunity to publish on various social networks and add new people to his flock. In exemplary embodiments, the user can connect the different networks. A network access pop-up appears when a user wants access to his contacts in any other network. This could be sharing something on a social network e.g. a Tweet or a post, or it could be actually connecting to a network with credentials.

As discussed above, the user sees her close contacts 14 on the user interface 20 as individual images within bubbles 24, with each bubble corresponding to a close contact 14 with the contact's picture inside the bubble. The bubbles 24 corresponding to the close contacts 14 are in gray color or grayed out as a default setting. A Your Nest-Like Someone function allows the user to see the public profile of each close contact 14, which becomes accessible when the user presses more deeply on a bubble 24. In exemplary embodiments, it is also where the user identifies the people who matter most by clicking on the heart symbol 17. There also may be an option to block people. If the user clicks one in the upper left corner, this blocks people; another click in the same spot unblocks the person. When the user selects a close contact 14 to be invited to a social gathering, the bubble 24 of that contact becomes activated and changes to a different color.

In exemplary embodiments, as best seen in FIG. 13, certain confidentiality features are provided. By clicking on confidentiality from the Profile-Intro page, the user accesses a view on his data and how it can be shared. By designating Private, Cautious or Open, the user decides what level of data sharing 19 she wishes to allow. The ‘private’, ‘cautious’ or ‘open’ status is a starting point. Users also have the opportunity to change their settings to further customize their confidentiality preferences. The user has some mandatory fields and for the rest, he can add the fields he wants. For instance, the user can reduce access to his data, determine how the data is used, and adjust levels of confidentiality for different contacts. Each function has one or more screens or pop-ups that appear on the user interface when the user utilizes the function. Frequently asked questions (FAQ) screens are also provided where each tap on a bird reveals a new item in the FAQs and, once the FAQs are completed, all the birds and the background appear in color.

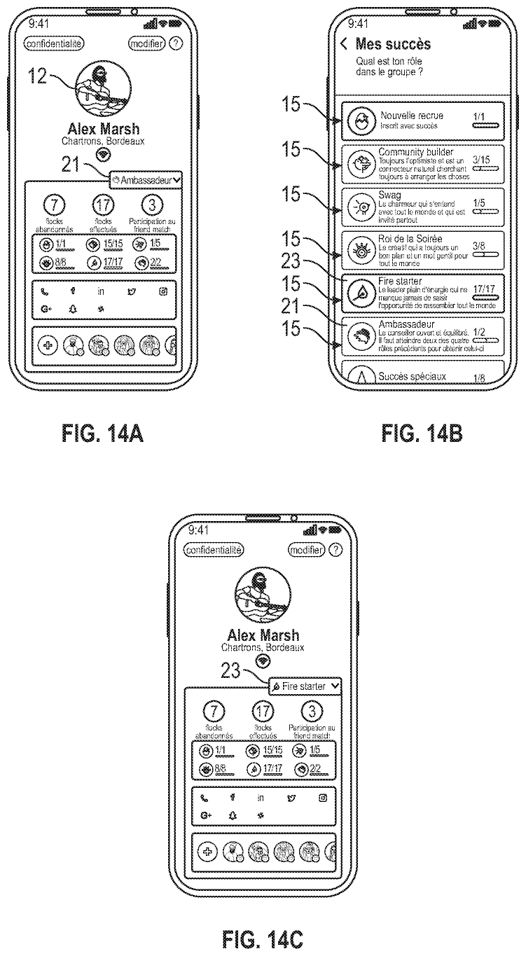

Referring to FIGS. 14A-14D, exemplary embodiments include unique and substantive profile options that reflect the user's personality and behavior in the app. For example, a screen or set of screens display and allocate the role she has in the app. Each user receives a new rookie badge from the start. The mobile app may have a screen or set of screens called “Ambassador.” This represents the business card of the user, sometimes called a flocker. From this map, the user can view his progress, his different badges 15 and see what type of flocker he is. The Ambassador option 21 is only available if the user has obtained two of the following four badges: Firestarter 23, Community Builder, Party King, Soul of the Party, or SWAG. A user can acquire multiple badges and once the user has more than one badge, she can choose the one she wants to display. If they only have a single badge i.e. the new recruit, then this is the only one they can select. One or more Rate Flock screens or pop-ups appear after an engaging action, e.g., after the first flock, after the 10th if not already noted and every ten, after having a badge, or after playing a match (discussed in more detail herein) ten times sharpened the first time.

When the user changes his or her role, certain elements of his profile may change. The change could be a change in color or other difference, depending on the new role. In exemplary embodiments, a screen or set of screens allows the user to see in detail the evolution of his badges. He can access it by clicking on the badge inserts from his profile. By clicking on each badge, he can see what steps he needs to earn the next badge. The roles become full color when he has all the badges of a category. This allows him to see what roles the user has in his group.

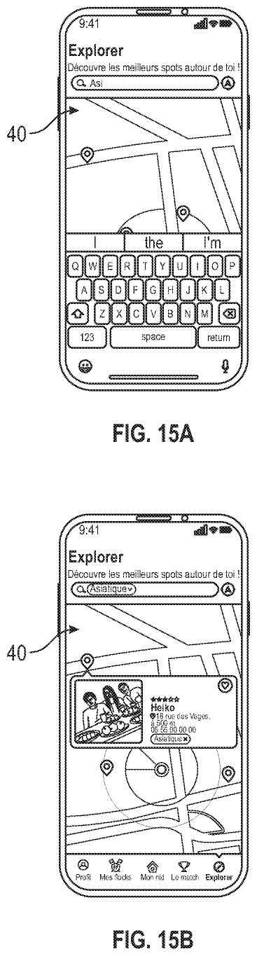

As shown in FIGS. 15A and 15B, exemplary embodiments include one or more Explorer screens 40 so the user can explore nearby restaurants. The user may be directly geolocated and can therefore see around him the nearest merchant options for social gatherings. This feature allows him to discover his neighborhood. The user can then activate filters, which will allow her to see another selection. The user decides the filters, and the system may utilize a predictive text to suggest what they will put. The initial selection presented is random and may include one expensive merchant, one less expensive merchant, and three merchants in the middle price range. If the user clicks on a restaurant, it disappears from the map and is replaced by a new fifth suggestion. The user has the opportunity to indicate the places he likes. Likes do not go anywhere in the app but are used to weight the algorithm indicating the generation of restaurant peers. The app also takes into account what all participants like to suggest as restaurant peers.

With reference to FIGS. 5A-5C, 6A-6B, 7-8 and 16A-22B, exemplary operation of facilitating a spontaneous gathering will now be described, starting with the creation of a flock, or group 18 of invited close contacts 14. To start, the organizer 12 clicks on her profile page and goes to the part of the profile where she can view, at any time, the people she has listed as those that matter most to her, i.e., her close contacts 14. This part of the profile is labeled “Your Nest” and is the starting point for creating a first flock. The trigger that may generate the organization and implementation of a spontaneous gathering with close contacts who are in close proximity to the user may be referred to as a “Magic Moment.” The Magic Moment is initiated when the user 12 receives a notification informing him that one or more of his close contacts 14 is in a close environment or zone of close proximity and the close contact's calendar shows that he or she is free at that time. In exemplary embodiments, the close proximity of at least two close contacts triggers a Magic Moment. Because of this Magic Moment notification, the user 12 decides to create a flock, i.e., invite a group 18 of close contacts 14 for a spontaneous social gathering.

The Magic Moment is one of the unique advantageous features of disclosed systems and methods, i.e., the special alignment of the user and one or more his close contacts based on geolocation, proximity of the relationship, and freedom to meet. In other words, any user can be notified when a close contact—a person who matters most to him or her whom she wants to see in person—is nearby and may be available to meet. Alternatively, the user 12 might proactively decide to send invitations for a spontaneous social gathering on her own without specific knowledge of the proximity of her close contacts 14.

As illustrated in FIGS. 5A-5C, this Magic Moment Notification informs that user that Alex has returned from vacation so the creation of a flock or group 18 is suggested. Note that this is what the guest sees. The guest is invited to a group because Alex has returned from vacation. Having received a notification that a close contact (Alex) is nearby, the user or organizer 12, in this example, Teddy, selects and configures in his nest which of his other close contacts 14 he wants to invite to this flock or gathering with Alex. If the user wants to search the database of close contacts, he scrolls (right or left) among his close contacts' bubbles 24. In exemplary embodiments, a search bar 41 may be displayed. All other close contacts, the potential participants, are grayed out before the user selects them. If he selects them, they change to color and their video comes alive. If the user makes a short press, he selects them; if he makes a long press, he can see their profile card (public pop-in). The user chooses to continue once he has selected the close contacts he wants to add to his flock.

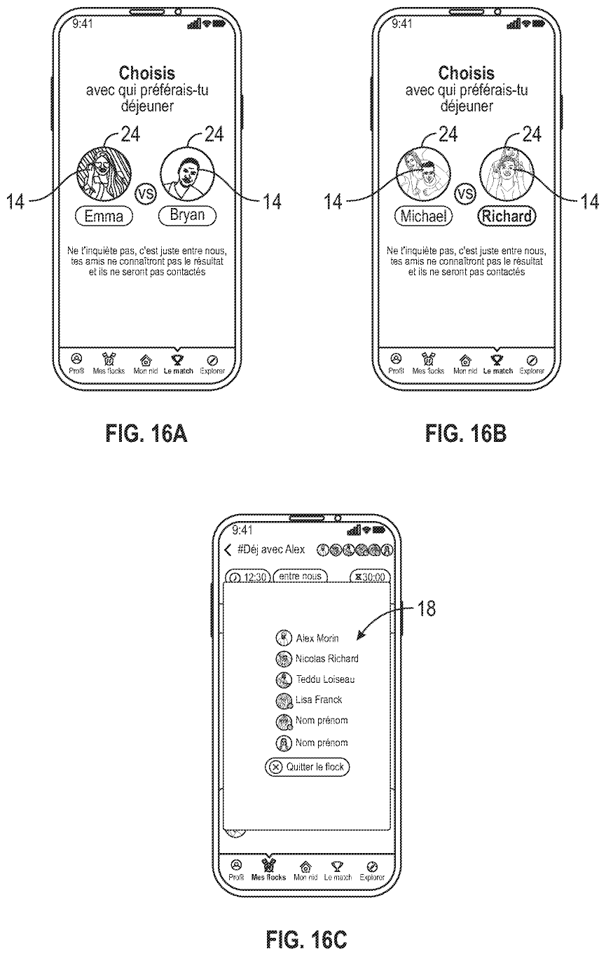

In exemplary embodiments, the process for selecting close contacts 14 for a group or flock 18 is provided in the form of a game. Via a series of Match screens shown in FIGS. 16A and 16B, the organizer 12 selects the person with whom he would prefer to meet. The game could be endless. Also included are people who have not downloaded the app but who are part of the user's phone book. Only one person can appear in more than one part. Each time a person wins a match with another person, his bubble in the nest becomes a little larger, and if a person loses in a match, his bubble becomes a little smaller. This is how there may be different sizes of bubbles in the user's nest over time.

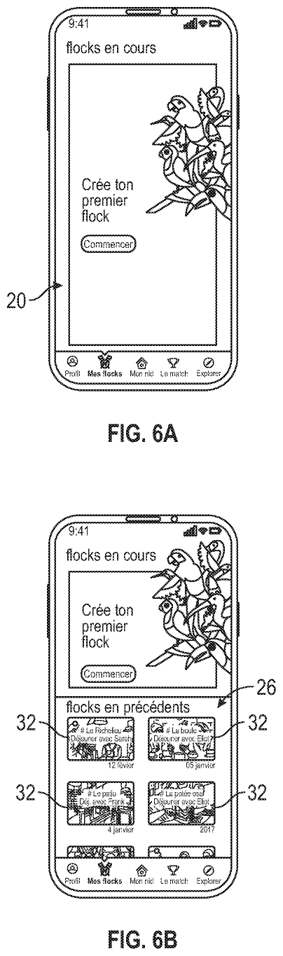

A series of “My Flocks Summary” pages may be provided to indicate the user's flock status and progress. For example, a first summary screen is visible only when the user has not yet created a flock or participated in any flocks. A second summary screen might be visible if the user has participated in flocks but never created them himself. A third type of summary screen may indicate that the user has flocks in progress and she has already flocked. A fourth would indicate that the user has clicked on previous flocks and so has more flocks that appear on the screen. If a user clicks on a previous flock from any of the second, third or fourth screens, he is directed to an evaluation page that also contains the chat from the flock. The user/organizer can see his previous and in-progress flocks by accessing a screen labeled “Add Super Flocks” or something similar, illustrated in FIGS. 6A and 6B. This is the screen that shows the organizer's current activity and history.

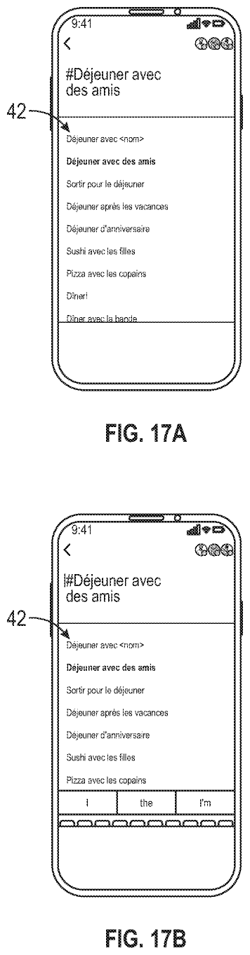

Next, via one or more Define Event screens 42 (FIGS. 17A-17B), the organizer chooses the main criteria for the flock. In exemplary embodiments, the first criterion is the title, which can either be chosen from the proposed title such as “Lunch with friends” or can be customized by the user. The next criterion is the proposed time of the gathering. The hour is adjustable to the quarter of an hour. Define Event screens facilitate this process with the following functionalities: Choose Name, Enter Name, Change Time. An Alternatives screen allows the organizer to select a pre-filled name or decide to create his own. It can also change the time or choose another pair. Another exemplary criterion relates to open or closed invitation options for the close contacts 14 the organizer is inviting. For instance, the organizer can select “between us” which means that the invited close contacts cannot invite more people to the flock, or “+a friend” which means that each invited close contact can invite another friend.

In exemplary embodiments, the organizer 12 can choose two or three new proposals at random, once. Once the settings are complete, the organizer 12 can send an invitation to his close contacts 14. The bubbles 24 of the invited close contacts 14, or participants, appear on the user interface. The hours that appear may be those of the next meal. In exemplary embodiments, they are set every quarter of an hour. The time block may vary depending on the type of gathering. For example, they could be 15-minute blocks for a coffee but 30 minutes for a meal. The organizer may also be able to specify the time block she wants for the gathering. In exemplary embodiments, the participants can invite or add an additional one of their close contacts while the vote is in progress. More particularly, an Add A Friend Pop In in the voting page may indicate that a close contact can add a friend. If the close contact clicks on “+a friend”, the she sees a window where she can choose a friend. It is important to note that friends in this window exclude anyone who has already been invited to the event. As soon as the last person has voted and the vote is closed, it is no longer possible to invite or add anyone else.

Once a flock for a spontaneous gathering is launched, the user or organizer 12 might see a First Firestarter Badge indicative of the first flock and showing the invited close contacts 14, or participants. In exemplary embodiments, this screen is only briefly displayed, for about 2-3 seconds. A First Time User Guide pop-up now may appear explaining to the organizer 12 what she can do while waiting for answers for her flock. As its name suggests, this pop-up appears only once, the first time a user organizes a flock. Next, a Flock Confirmed notification alerts the invited close contacts 14 that a flock has just been created and instructs them to join as participants or flock guests.

Each close contact 14 invited to join the flock sees herself in the center of her screen and the other invited close contacts arrayed around her. It is the invited close contact 14 who is in the center of the screen, except for the organizer 12 creating a flock from scratch in which case it is the organizer in the center. Each user is always at the heart of his screen on his own phone. As shown in FIG. 16C, one or more screens or pop-ups allow the organizer to see who the participants in the group or flock are by clicking on the top right of the screen. There is also a pop-up if one of the close contacts 14 says he wants to leave the flock.

In exemplary embodiments, one or more Invitation Rejection screens indicate that one or more guests (close contacts invited to participate) cannot join the flock. There could still be a flock with just two people. However, if none of the invited close contacts 14 responds positively, the flock is abandoned. The flock can be canceled by the organizer leaving the flock himself (by clicking on the list of friends and choosing to leave). In exemplary embodiments, one or more Epic Flock Failure screens indicate a failed flock. An Intro screen starts with animations linked with birds symbolizing the failure. In exemplary embodiments, the passage of different birds takes place in parallel. As shown in FIG. 22A and 22B, an Epic Flock Failure Sweep page 44 requires the organizer to sweep the feathers from the failure of the flock. The organizer may then be provided the option to return to her nest. On an Epic Flock Failure-Your Nest screen, the sentence disappears the next time the organizer comes back to his nest.

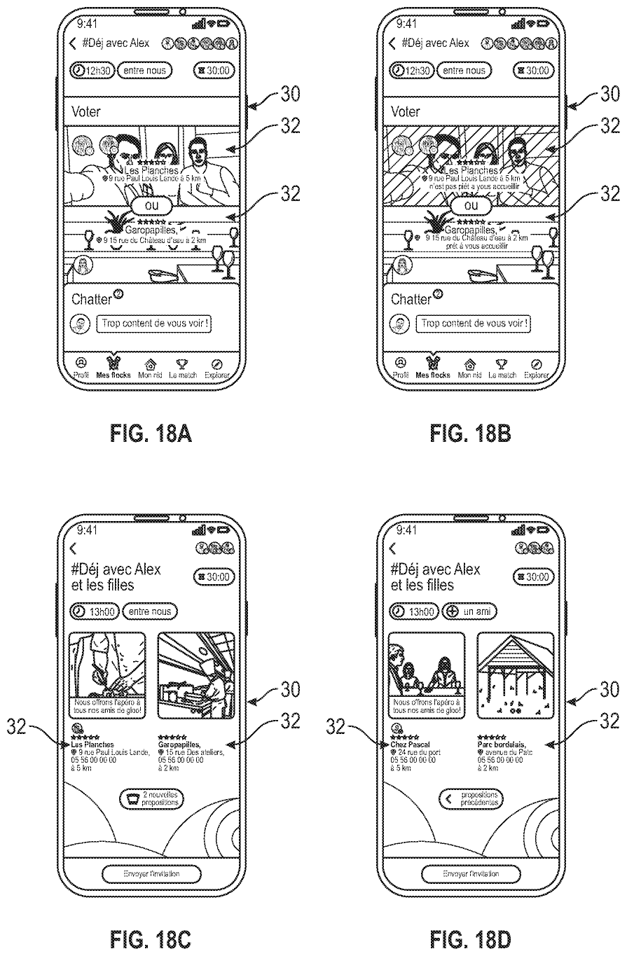

Turning to FIGS. 18A-18D, the steps related to voting on merchants or locations for the gathering will now be described. In exemplary embodiments, a screen or series of screens present options for restaurants, bars, cafes, shops, etc. to meet at. In exemplary embodiments, the participants, or invited close contacts, see a choice between two suggested merchants and confirm their preference between the two. As discussed above, there may be a series of options for the organizer 12 to choose between two suggested merchants 32, narrowing down the number of merchants with a repeated choice between two different merchants. Once the organizer 12 has selected the pair of suggested merchants 32 she wants to submit to the group 18, each invited close contact 14 sees only that final pair and can choose between the two. If no one has voted within 30 minutes, the flock will expire. Each of the suggested merchants may receive a notification that they are being considered as potential gathering locations.

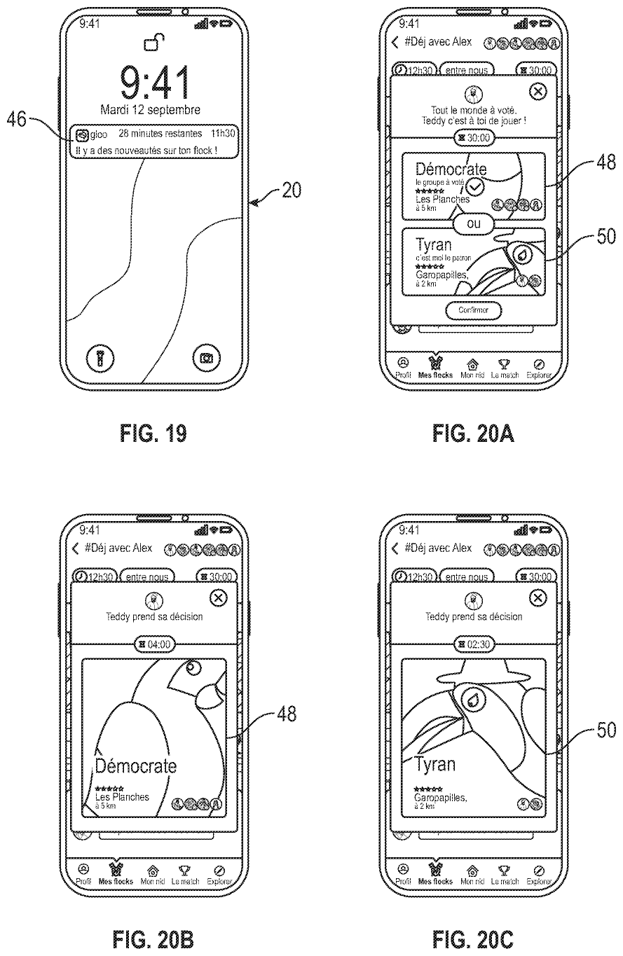

As shown in FIG. 19, the organizer receives a notification 46 when everyone has voted. In exemplary embodiments, the notification informs the organizer 12 whether a gathering location has been selected by group 18 and which is the selected location 34. Alternatively the notification lets the organizer 12 know the result but does not indicate whether it is a positive or negative update, i.e. whether a restaurant has been selected. This is intentional, so that the organizer is more inclined to open it. In exemplary embodiments, it then remains for the organizer to vote and decide.

With reference to FIGS. 20A-20C, the close contacts 14 in the group 18 may see a series of Restaurant Confirmation screens that scroll for the participants until the organizer makes his decision. The timer shows that while the organizer/host decides, guests see different screens. In exemplary embodiments, the organizer has five minutes to make a final decision and these screens try to keep the guests busy during this time. The organizer can accept or reject the selected merchant 34. If the organizer 12 accepts the selected merchant 34, he is labeled a “democrat” 48. More particularly, a screen will show either that the organizer 12 is a tyrant or a democrat, i.e., he followed the majority's choice. If the choice of the group was 50/50, the app will say the organizer is a democrat. If the organizer 12 rejects the selected merchant, her or she is labeled a “tyrant” 50.

In exemplary embodiments, the selected merchant, e.g., restaurant, café, bar, receives a notification as soon as the flock is confirmed. More particularly, the scheduling system may send a notification to the selected merchant or gathering location about accommodating the group. If the restaurant responds positively that it can accommodate the group, a notification text is displayed such as “ready to greet you” or “ready to welcome you.” The restaurant can pre-define the message it wants to be sent to groups. If the restaurant does not confirm the choice made by the group of flockers, the group 18 may still go to that restaurant but it is not guaranteed that the restaurant can accommodate the group at that time.

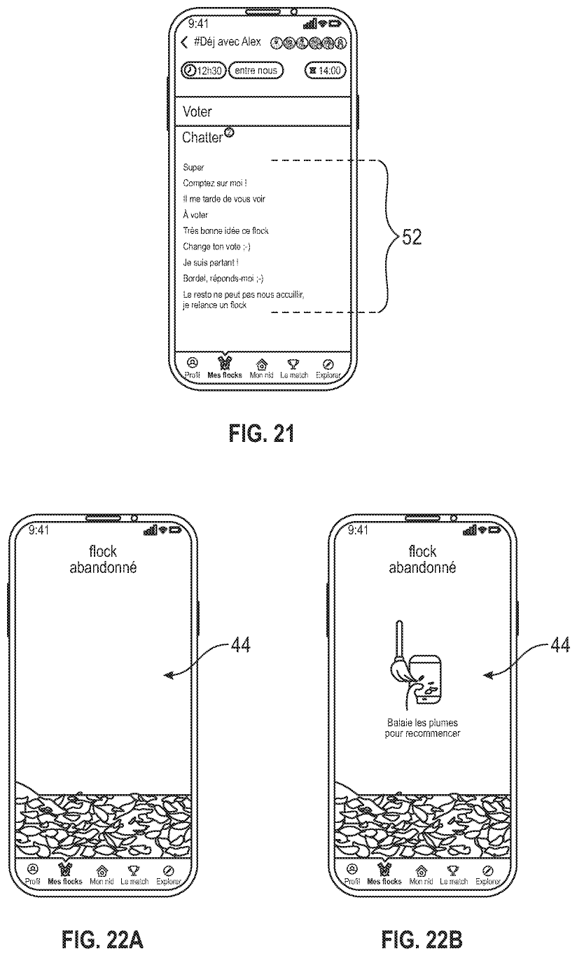

Exemplary embodiments may include a chat interface, illustrated in FIG. 21, which provides the group with the ability to chat with the restaurateur or other selected merchant. These chats may use pre-defined messages 52, which are located in the same place. All messages before the event are predefined. The selected merchant/restaurateur sees only the pre-defined messages and does not have access to the internal messages of the group. En Route for the Restaurant screens allow flockers to follow fellow flockers' progression to the selected merchant/gathering location. In exemplary embodiments, nobody is informed where the others in the group are but only how far (in time) they are from the selected restaurant. Here users can also continue chatting. The discussion is made of predefined messages as long as the flock is not finished. A pop-up notification indicates that the flock has arrived at the restaurant. In addition, the app knows the event is over when the flockers leave the restaurant after the gathering.

As indicated above, the app communicates with selected merchants through queries to accommodate a flock and pre-defined messages. Additional merchant-side functionality is provided in the form of a mobile application for businesses. This app may include a notification screen or pop-up alerting the selected merchant that a flock has arrived at the gathering location. One or more Profile Pages provide the restaurant owner or other merchant the ability to enter the predefined messages that he wants to be able to send to future customers, change his name, his bank details, his subscription, or add a new restaurant. One or more Flock Management pages provide the restaurant owner or other merchant the opportunity to consult the flocks he has in progress, to interact with his future customers to validate their request, and to consult his old flocks. A Stats Page showing the restaurant's statistics allows the merchant to see the opinions that people have left him, and what are the top messages. The Stats Page may also indicate how much he has victories vs. defeats from groups' voting results and what position his location is in on a leaderboard.

In exemplary embodiments, the app provides Rating Notifications. More particularly, a notification arrives at the organizer after the social gathering. The exact moment when users see it is variable. It can be immediately after the event, a few hours later, or the next day. In exemplary embodiments, it is not at the same time for everyone in the group. Via one or more Ratings Pages, the organizer can indicate her appreciation of the experience. Only the organizer can rate the establishment. He and the participants in the flock can share photos with the group. Participants can thank the organizer and continue chatting. All guests can provide their opinion of the event. Certain small icons at the top of a ratings page may be linked to the restaurant's business card (which can be scanned to always have the details of the restaurant at hand), and the arrow button corresponds to the “one-click button to replay the flock.” The app can also “interrupt” the chat and/or put it in mute in this part of the experience.

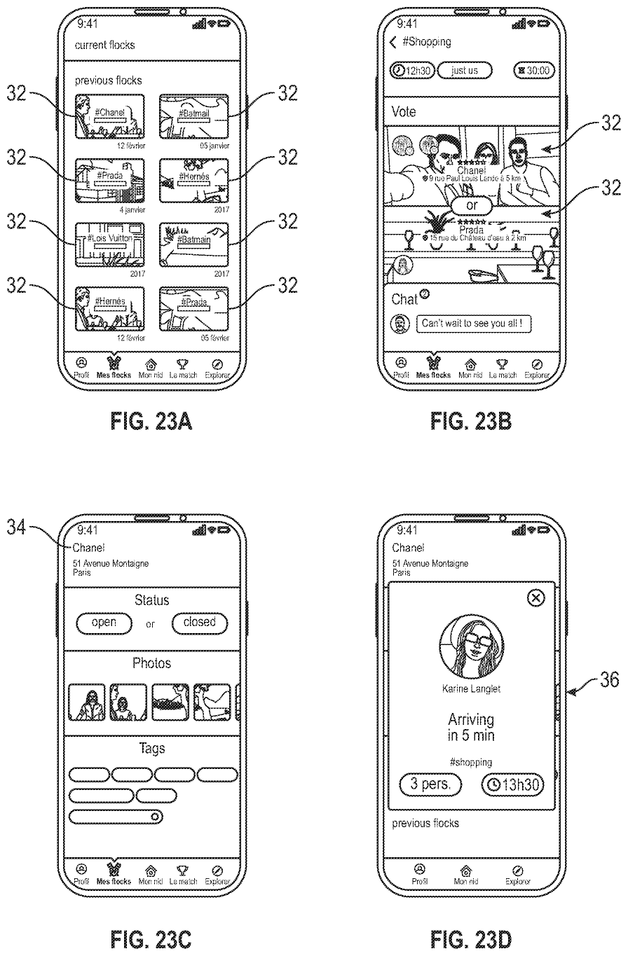

It should be noted that disclosed systems and methods have wide application beyond scheduling social gatherings. The ability to connect close contacts and incorporate geolocation could be utilized in industries other than hospitality and restaurant services. For example, shopping, fashion outlets, and travel agents could benefit from using the mobile app and connecting with consumers who use the app. In the same way the app brings close friends and family together for a spontaneous meal or drink, it could facilitate a shopping trip at a mall or designer store. As illustrated in FIGS. 23A-23D, the voting methodology described in detail above could be utilized to vote for a fashion shop, clothing store, or mall for close contacts to meet at. Similarly, exemplary voting systems and scheduling systems could be used to organize a social gathering for almost any kind of event or location, from movies to theater, travel, concerts, etc.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

Thus, it is seen that improved systems and methods for facilitating spontaneous gatherings are provided. It should be understood that any of the foregoing configurations and specialized components may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

1. A computer-implemented system of facilitating social gatherings, comprising:
a user interface;
a contact database comprising a limited number of an organizer's close contacts, a close contact appearing on the user interface as an individual image within a bubble;
a geolocation system determining locations of the close contacts; and
a scheduling system comprising a suggestion system suggesting merchants and a voting system;
the scheduling system enabling the organizer to select one or more close contacts forming a group and to send an invitation for a gathering containing suggested merchants to the group;
the voting system enabling the group to vote on the suggested merchants; and
the scheduling system sending a notification to the selected merchant having the most votes.

2. The system of facilitating social gatherings of claim 1 wherein when the organizer selects the at least one close contact the corresponding bubble is activated.

3. The system of facilitating social gatherings of claim 2 wherein the bubble is grayed out before being activated and changes to color when activated.

4. (canceled)

5. The system of facilitating social gatherings of claim 1 wherein the scheduling system provides a notification to the organizer when every close contact in the group has voted on a suggested merchant.

6. The system of facilitating social gatherings of claim 5 wherein the suggested merchant receiving the most votes becomes a selected merchant.

7. The system of facilitating social gatherings of claim 6 wherein the voting system enables the organizer to accept or reject the selected merchant.

8. The system of facilitating social gatherings of claim 1 wherein the scheduling system allows the group to observe which close contacts in the group plan to attend the gathering.

9. The system of facilitating social gatherings of claim 1 wherein the geolocation system tracks each close contact's movement toward the selected merchant including informing the organizer how much time it will take for each close contact in the group to arrive at the selected merchant.

10. The system of facilitating social gatherings of claim 1 wherein the geolocation system provides a notification to the organizer when a close contact is in a zone of close proximity to the organizer.

11. The system of facilitating social gatherings of claim 10 wherein the geolocation system informs the organizer how much time it will take for each close contact in the group to reach the organizer.

12. (canceled)

13. A method of scheduling social gatherings, comprising:
maintaining a contact database comprised of a limited number of an organizer's close contacts;
displaying each close contact as an individual image within a bubble;
determining locations of the organizer's close contacts;
enabling the organizer to select one or more close contacts forming a group;
suggesting merchants to the organizer;
enabling the organizer to send an invitation to the group for a gathering containing suggested merchants;
enabling the group to vote on the suggested merchants, the suggested merchant receiving the most votes becoming a selected merchant;
enabling the organizer to accept or reject the selected merchant; and
sending a notification to the selected merchant.

14. The method of claim 13 when the organizer selects the one or more close contacts the corresponding bubbles are activated.

15. The method of claim 13 wherein enabling the group to vote on the suggested merchants comprises providing each close contact in the group the ability to vote by making one or more choices between two suggested merchants.

16-17. (canceled)

18. The method of claim 13 further comprising allowing the organizer to observe which close contacts in the group plan to attend the gathering.

19. The method of claim 13 further comprising tracking each close contact's movement toward the selected merchant including informing the organizer how much time it will take for each close contact in the group to arrive at the selected merchant.

20. The method of claim 13 further comprising providing a notification to the organizer when a close contact is in a zone of close proximity to the organizer.

21-22. (canceled)

23. A computer-implemented marketplace for connecting merchants and groups of customers, comprising:
a registration system enabling a merchant to register and create a merchant profile and enabling the merchant to connect to a social network of customers; and
a scheduling system comprising a suggestion system, a messaging system, and a voting system;
the suggestion system suggesting merchants to a customer;
the messaging system enabling the merchant to send a message to a group of customers choosing among suggested merchants for a location for a social gathering;
the voting system enabling a group of customers to select a merchant for a social gathering and send a notification to the selected merchant.

24. (canceled)

25. The marketplace of claim 23 wherein the scheduling system enables the customer to select one or more close contacts forming a group and to send an invitation for a gathering containing suggested merchants to the group.

26. The marketplace of claim 25 further comprising a voting system enabling the group to vote on the suggested merchants.

27. The marketplace of claim 26 wherein the voting system enables the group to vote on the suggested merchants by providing each close contact in the group the ability to vote by making one or more choices between two suggested merchants.

28. (canceled)
